(19) United States
(12) Patent Application Publication
(10) Pub. No.: US 2014/0320119 A1
(43) Pub. Date: Oct. 30, 2014

(54) ROTATION SENSING APPARATUS

(71) Applicant: DENSO CORPORATION, Kariya-city (JP)

(72) Inventors: Hiroyuki Tsuge, Nisshin-city (JP); Tomoya Takayama, Kariya-city (JP)

(73) Assignee: DENSO CORPORATION, Kariya-city (JP)

(21) Appl. No.: 14/258,337

(22) Filed: Apr. 22, 2014

(30) Foreign Application Priority Data
Apr. 25, 2013 (JP) 2013-092776

(51) Int. Cl. G01D 11/24; G01P 3/44

(52) U.S. Cl. CPC G01D 11/245; G01P 3/44
USPC 324/207.25

(57) ABSTRACT

A sensor main body includes sensing elements, which sense rotation of a rotatable body. A first molded body is made of a resin material and covers the sensor main body. The sensor main body is placed at a distal end portion of the first molded body. A cover covers the distal end portion of the first molded body. An electrically conductive member is placed between the cover and the sensor main body and is electrically connected to a ground terminal of the sensor main body.

### CROSS REFERENCE TO RELATED APPLICATION

This application is based on and incorporates herein by reference Japanese Patent Application No. 2013-92776 filed on Apr. 25, 2013.

### TECHNICAL FIELD

The present disclosure relates to a rotation sensing apparatus.

### BACKGROUND

A rotation sensing apparatus, which senses rotation of a rotatable body of a vehicle, is often placed in an environment that is exposed to static electricity that is generated around the rotatable body. The static electricity is generated through, for example, friction between a rubber drive belt of an internal combustion engine and a pulley, or friction between a tire of the vehicle and a road surface. A housing of the rotation sensing apparatus is normally made of a resin material. Therefore, the housing may be charged with the static electricity to cause electrification of a sensor main body (e.g., a package of a Hall IC) placed in the housing. The electrification of the sensor main body may possibly cause an error of the sensor. In order to address the above disadvantage, it is effective to place the rotation sensing apparatus (the sensor main body) apart from the source of the static electricity. However, in the vehicle, it is often difficult to change the installation location of the rotation sensing apparatus due to a limited available space in the vehicle.

One method, which limits the static electrification of the rotation sensing apparatus, is the covering of the rotation sensing apparatus with, for example, a metal case connected to a ground. This method is widely used in other apparatuses, which are other than the rotation sensing apparatus. However, in the case of the rotation sensing apparatus, when the sensor main body is covered with the metal case, a size of the entire apparatus is disadvantageously increased, thereby resulting in the difficulty of installing the rotation sensing apparatus in the vehicle. Also, when the metal case is exposed to the external environment, corrosion may possibly occur to deteriorate the reliability of the rotation sensing apparatus. Furthermore, the manufacturing costs may be disadvantageously increased due to the costs of the metal case and the additional assembling costs of the metal case. Also, it has been proposed to use the metal case as the housing of the rotation sensing apparatus. It is desirable that the metal case is made of a material (a non-magnetic material in a case of a magnetic sensor), which can withstand the external environment and does not have an influence on the sensing result. However, it is required to form a thin wall of the metal case to avoid the influence on the sensed result. As a result, the metal case results in the higher costs and the lower productivity in comparison to the resin housing. Furthermore, it has been proposed to coat an anti-static material, such as a conductive coating material, to a surface of the resin housing of the rotation sensing apparatus. However, in a case of the vehicle, which is under the harsh environment (e.g., the environment exposed to heat, water, and/or oil), the sufficient reliability of the anti-static material cannot be ensured. The above proposal also suggests to form the resin housing as the conductive housing. However, when the resin housing, which insulates between the sensor main body of the rotation sensing apparatus and the outside of the resin housing, is formed as the conductive housing, short-circuiting may possibly occur in the circuit of the sensor main body or between terminals.

JP2010-197137A teaches a technique of addressing the above disadvantage. Specifically, according to JP2010-197137A, a non-conductive resin case is provided to cover a sensor main body (a sensing circuit and a wire harness), and a fixing member, which is made of a conductive resin material, is used to fix the resin case and is grounded.

However, since the conductive resin material is expensive, the costs of the rotation sensing apparatus are disadvantageously increased. Furthermore, the conductivity of the conducive resin material is implemented by adding, for example, carbon. Therefore, the conductivity of the conductive resin material is lower than that of the metal case. Thus, the sufficient anti-static shield effect cannot be achieved.

### SUMMARY

The present disclosure addresses the above disadvantages. According to the present disclosure, there is provided a rotation sensing apparatus, which includes a sensor main body, a first molded body, a cover, and an electrically conductive member. The sensor main body includes at least one sensing element, which senses rotation of a rotatable body. The first molded body is made of a resin material and covers the sensor main body. The sensor main body is placed at a distal end portion of the first molded body. The cover covers the distal end portion of the first molded body. The electrically conductive member is placed between the cover and the sensor main body and is electrically connected to a ground terminal of the sensor main body.

### BRIEF DESCRIPTION OF THE DRAWINGS

The drawings described herein are for illustration purposes only and are not intended to limit the scope of the present disclosure in any way.

FIG. 1 is a longitudinal cross-sectional view showing a structure of a rotation sensing apparatus according to an embodiment of the present disclosure;

FIG. 2 is an enlarged longitudinal cross-sectional view of an area II in FIG. 1;

FIG. 3 is a perspective view showing a state where an electrically conductive member is bonded to a sensor main body while a wire is connected to the sensor main body according to the embodiment;

FIG. 4 is a perspective view showing a first molded body of the embodiment; and

FIG. 5 is a longitudinal cross-sectional view showing a state in which the rotation sensing apparatus of the embodiment is installed to a knuckle of a vehicle.

### DETAILED DESCRIPTION

An embodiment of the present disclosure will be described with reference to the accompanying drawings. In the drawings, components, which correspond with each other, or components, which have the same function, will be indicated by the same reference numerals throughout the following description and will not be described redundantly.

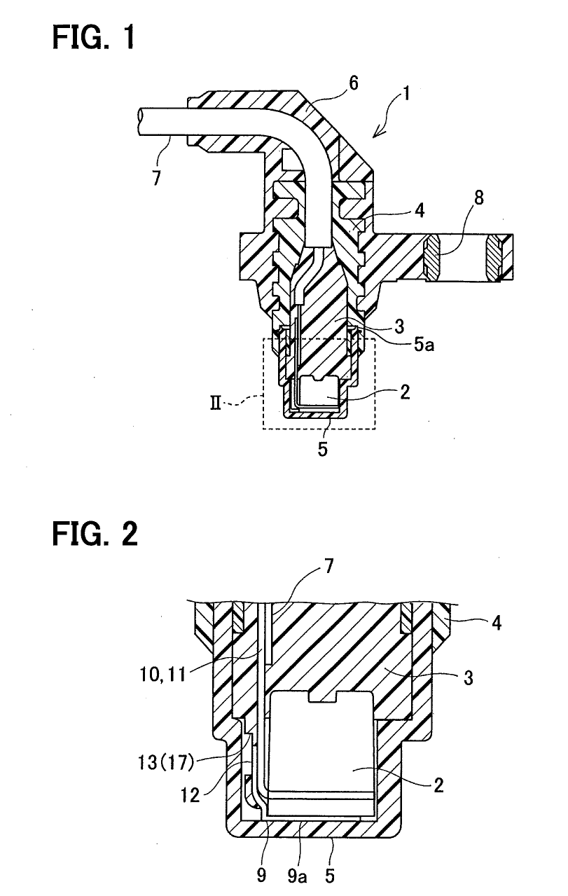

As shown in FIGS. 1 to 5, a rotation sensing apparatus 1 of the present embodiment includes a sensor main body 2, a first molded body 3, a cover 5, a second molded body 4 and a third molded body 6. The sensor main body 2 senses rotation of a rotatable body, such as a gear rotor 16. The first molded body 3 covers and integrally holds the sensor main body 2 and a wire 7 connected to the sensor main body 2. The cover 5 covers a distal end portion of the first molded body 3. The second molded body 4 covers and integrally holds the first molded body 3 and the cover 5. The third molded body 6 holds an outer peripheral portion of the second molded body 4 and forms an installation member of the rotation sensing apparatus 1.

As shown in FIG. 5, the rotation sensing apparatus 1 is installed to a knuckle 14 with a bolt that is inserted through a through-hole 8 such that a distal end surface of the cover 5 placed at the lower end of the rotation sensing apparatus 1 is opposed to the teeth of the gear rotor 16. The gear rotor 16 is fitted to to a drive shaft 15, which is rotatably supported by the knuckle 14. The sensor main body 2 senses the amount of rotation of the drive shaft 15, which is rotated synchronously with the tire at the time of rotating the tire. Then, the sensor main body 2 outputs a signal, which indicates the sensed result, to an in-vehicle device through a power source terminal 11, a ground terminal 10 and the wire 7.

The sensor main body 2 includes known sensing elements (e.g., Hall elements) 2a and a known processing circuit (not shown) to sense a change in a magnetic field around the sensor main body 2. In the present embodiment, the number of the sensing elements 2a is two. Furthermore, in a case where the sensing subject is the gear rotor 16, the sensor main body 2 further includes a permanent magnet. When the gear rotor 16 is rotated, the sensing elements 2a of the sensor main body 2, which are opposed to the teeth of the gear rotor 16, sense the magnetic field, which changes in a pulsed manner. The sensor main body 2 outputs the information of the rotation of the drive shaft 15 (the tire) as the pulse signal (square wave signal) by converting the change in the magnetic field into the square wave through the processing circuit.

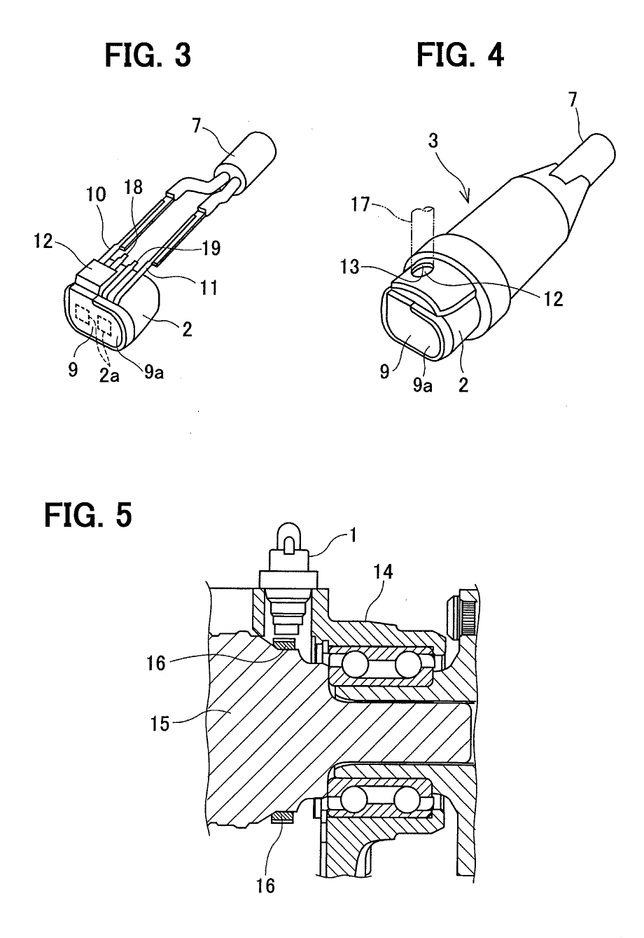

As shown in FIGS. 2 and 3, an electrically conductive member (hereinafter simply referred to as a conductive member) 9 is installed to a distal end surface of the sensor main body 2. Preferably, the conductive member 9 is a metal thin plate, which is integrally and seamlessly formed. It is preferred to use a metal tape, which can be easily handled, as the conductive member 9. However, in the case where the sensing elements 2a are the magnetic field sensing elements, such as the Hall elements, the conductive member 9 must be made of a non-magnetic material, such as copper or aluminum. The conductive member 9 includes a main body portion 9a that is slightly smaller than a size of the distal end surface of the sensor main body 2. A contact portion 12, which extends from the main body portion 9a, is placed at a location, which corresponds to the ground terminal 10 that extends along a lateral surface of the sensor main body 2 from the distal end side to the rear side. An electrically conductive adhesive agent (hereinafter referred to as a conductive adhesive agent) is coated to an opposed surface of the conductive member 9, which is opposed to the sensor main body 2. Therefore, when the contact portion 12 is bent at a right angle after bonding of the main body portion 9a of the conductive member 9 to the distal end surface of the sensor main body 2, the conductive member 9 is bonded to the ground terminal 10 and has a ground potential of the sensor (the processing circuit). One example of the conductive member 9 is copper foil coated with the conductive adhesive agent and has a thickness of 70 μm (a sum of a thickness of the copper foil and a thickness of the conductive adhesive agent).

Besides the ground terminal 10, the sensor main body 2 has three other terminals. In FIG. 3, the ground terminal 10 is the left end one of the four terminals, which are arranged one after another in a row. Furthermore, in FIG. 3, the right end one of the four terminals is a power source terminal 11. The contact portion 12 is configured such that besides the ground terminal 10, the contact portion 12 is also contactable with one or more of the adjacent terminals 18, 19, which are adjacent to the ground terminal 10. This configuration of the contact portion 12 can advantageously increase a bonding surface area of the contact portion 12 and can advantageously stabilize the bonding of the contact portion 12. However, the adjacent terminal(s) must be a terminal, which has the same electric potential as that of the ground terminal, an open terminal, or a terminal, which does not have an influence on the processing circuit upon electrical connection with the ground terminal. FIG. 3 shows the example, in which the contact portion 12 contacts the adjacent terminal 18, which is placed next to the ground terminal 10. However, as long as the above condition is satisfied, the contact portion 12 may also contact the other terminal 19, which is placed next to the terminal 18. Furthermore, the number of the terminals is not limited to four. That is, the number of the terminals may be larger than four. In such a case, the contact portion 12 may contact the four or more terminals, if desired. Corresponding wire elements (conductive lines) of the wire 7 are joined to the ground terminal 10 and the power source terminal 11, respectively, by, for example, welding or soldering.

The first molded body 3 is formed through injection molding. Specifically, the sensor main body 2 of FIG. 3, to which the wire 7 is connected and to which the conductive member 9 is bonded, is placed in a molding die (not shown) such that the sensor main body 2 is placed at the distal end portion of the first molded body 3. Thereafter, a molten resin material is injected into the molding die and is solidified to form the first molded body 3, in which the sensor main body 2 is insert-molded. Through this injection molding, as shown in FIG. 4, the sensor main body 2, the contact portion 12 and the connections of the ground terminal 10 and of the power source terminal 11 to the wire 7 are covered with the molding resin material. The molding resin material needs to be molded at a low pressure to avoid a damage of the sensor main body 2, which is insert molded with the molding resin material. Therefore, a hot-melt molding resin material (e.g., one-part solventless thermoplastic hot-melt adhesive) or an epoxy molding resin material is used as the molding resin.

The molding die, which is used to mold the first molded body 3, includes a pin 17. At the time of closing the molding die, a distal end surface of the pin 17 contacts the contact portion 12, which is bonded to the ground terminal 10 and the one or more of the adjacent terminals 18, 19. The pin 17 projects from a cavity surface of the molding die. The contact portion 12 is pressed with the pin 17, and thereby the contact portion 12 will not be curled by the molding pressure of the molding resin material. As a result, the contact portion 12 is covered with the molding resin material in the state where the good contact of the contact portion 12 with the ground terminal 10 is achieved. The first molded body 3 has a pin hole (serving as a trace indicating the presence of the pin 17 at the time of the molding) 13, from which the pin 17 is removed. Therefore, a part of the contact portion 12 of the conductive member 9 can be viewed through the pin hole 13.

As shown in FIG. 2, the cover 5 is configured into a cup form to cover the conductive member 9, the sensor main body 2 and the portion of the first molded body 3. The cover 5 is molded from a molding resin material, such as polybutylene terephthalate (PBT) or polyamide (PA).

The second molded body 4 is formed through injection molding. Specifically, the corresponding portion of the wire 7 and the first molded body 3 covered with the cover 5 are placed in a molding die (not shown), and a molten resin material is injected into the molding die and is solidified to form the second molded body 4, in which the corresponding portion of the wire 7 and the first molded body 3 covered with the cover 5 are insert molded. Through this injection molding, an opening end portion 5a of the cover 5, the first molded body 3 and the corresponding portion of the wire 7, which is adjacent to the first molded body 3, are covered with the molding resin material of the second molded body 4. Similar to the cover 5, the molding resin material of the second molded body 4 may be, for example, polybutylene terephthalate (PBT) or polyamide (PA). The opening end portion 5a of the cover 5 has an annular projection, which strengthen the connection of the cover 5 to the molding resin material of the second molded body 4 at the time of molding the second molded body 4. In this way, the fluid tightness of the connection between the cover 5 and the second molded body 4 against, for example, water and/or oil is achieved.

The third molded body 6 is formed through injection molding. Specifically, the second molded body 4 and the corresponding portion of the wire 7 are placed in a molding die (not shown), and a molten resin material is injected into the molding die and is solidified to form the third molded body 6, in which the corresponding portion of the wire 7 and the second molded body 4 are insert molded. Through this injection molding, the upper half of the second molded body 4 and the corresponding portion of the wire 7 located adjacent to the second molded body 4 are covered with the molding resin material. Similar to the second molded body 4, the molding resin material of the third molded body 6 may be, for example, polybutylene terephthalate (PBT) or polyamide (PA).

As discussed above, the rotation sensing apparatus 1 of the present embodiment includes the sensor main body 2, the first molded body 3, the cover 5 and the conductive member 9. The sensor main body 2 includes the sensing elements 2a, which sense the rotation of the rotatable body. The first molded body 3 is made of the resin material and covers the sensor main body 2. The sensor main body 2 is placed at the distal end portion of the first molded body 3. The cover 5 covers the distal end portion of the first molded body 3. The conductive member 9 is placed between the cover 5 and the sensor main body 2 and is electrically connected to the ground terminal 10 of the sensor main body 2.

With this construction, the conductive member 9, which is grounded to the ground (GND) level of the sensor, is placed between the rotatable body and the sensor main body 2 (the sensing elements 2a). Thereby, the conductive member 9 shields the sensor main body 2 from the static electricity and reduces the possibility of reaching of the electromagnetic wave to the processing circuit of the sensor main body 2. As a result, the erroneous operation of the sensor main body 2 can be advantageously limited. Furthermore, the conductive member 9 releases the electric charge, which is accumulated in the sensor main body 2, through the ground terminal 10. Thus, the electrification of the sensor main body 2 can be limited, and thereby the erroneous operation of the sensor main body 2, which is caused by the electrification of the sensor main body 2, can be limited.

Furthermore, the conductive member 9 is made of the metal thin plate coated with the conductive adhesive agent. The conductive member 9 includes the main body portion 9a and the contact portion 12. The main body portion 9a is bonded to the distal end surface of the sensor main body 2, and the contact portion 12 seamlessly extends from the main body portion 9a and is bonded to the ground terminal 10 of the sensor main body 2. Therefore, the conductive member 9 can be easily grounded with the simple structure.

The contact portion 12 is bonded to the one or more of the adjacent terminals (at least one terminal) 18, 19, which is placed adjacent to the ground terminal 10. Therefore, the reliability of the ground connection of the conductive member 9 can be improved.

The first molded body 3 is molded to cover the contact portion 12, which is bonded to the ground terminal 10 and the one or more of the adjacent terminals 18, 19. Therefore, the reliability of the ground connection of the conductive member 9 can be improved and stabilized.

Furthermore, at the time of molding the first molded body 3, the pin 17 of the molding die contacts the contact portion 12. Therefore, the curling of the contact portion 12 by the molding pressure of the molding resin material can be limited to achieve the good contact of the contact portion 12 with the ground terminal 10.

Furthermore, the molding resin material of the first molded body 3 is the hot-melt resin material, which is moldable at the low pressure. Therefore, the damage of the sensor main body 2 during the molding process can be limited.

Furthermore, the molding resin material of the first molded body 3 is the epoxy molding resin material, which is moldable at the low pressure. Therefore, the damage of the sensor main body 2 during the molding process can be limited.

In addition, the second molded body 4 is formed to cover the opening end portion 5a of the cover 5 and the first molded body 3. Therefore, the fluid-tightness of the sensor main body 2 is achieved to improve the environmental resistance.

Furthermore, since the rotatable body is the drive shaft 15 of the vehicle according to the embodiment, the rotational speed of the vehicle's tire can be accurately sensed.

The present disclosure is not limited to the above embodiment, and the above embodiment may be modified in various ways based on the principle of the present disclosure. Furthermore, it should be noted that the various modifications of the above embodiment should be within the scope of the present disclosure as long as the modifications do not deviate from the principle of the present disclosure.

What is claimed is:

1. A rotation sensing apparatus comprising:
a sensor main body that includes at least one sensing element, which senses rotation of a rotatable body;
a first molded body that is made of a resin material and covers the sensor main body, wherein the sensor main body is placed at a distal end portion of the first molded body;
a cover that covers the distal end portion of the first molded body; and
an electrically conductive member that is placed between the cover and the sensor main body and is electrically connected to a ground terminal of the sensor main body.

2. The rotation sensing apparatus according to claim 1, wherein:
the electrically conductive member is made of a metal thin plate coated with an electrically conductive adhesive agent; and
the electrically conductive member includes:
a main body portion that is bonded to a distal end surface of the sensor main body; and
a contact portion that extends from the main body portion and is bonded to the ground terminal of the sensor main body.

3. The rotation sensing apparatus according to claim 2, wherein the contact portion is bonded to at least one terminal, which is other than the ground terminal and is placed adjacent to the ground terminal.

4. The rotation sensing apparatus according to claim 2, wherein the first molded body is molded to cover the contact portion, which is bonded to the ground terminal and the at least one terminal.

5. The rotation sensing apparatus according to claim 4, wherein the contact portion is contacted with a pin of a molding die at a time of molding the first molded body.

6. The rotation sensing apparatus according to claim 5, wherein the resin material of the first molded body is a hot-melt molding resin material, which is moldable at a low pressure.

7. The rotation sensing apparatus according to claim 5, wherein the resin material of the first molded body is an epoxy molding resin material, which is moldable at a low pressure.

8. The rotation sensing apparatus according claim 1, further comprising a second molded body, which covers an opening end portion of the cover and the first molded body.

9. The rotation sensing apparatus according to claim 1, wherein the rotatable body is a drive shaft of a vehicle.
